(19) United States
(12) Patent Application Publication
(10) Pub. No.: US 2012/0203493 A1
(43) Pub. Date: Aug. 9, 2012

(54) APPARATUS, SYSTEM, AND METHOD FOR WIRES WITH WAVEGUIDES

(76) Inventors: William Kurt Dobson, Draper, UT (US); Zivile Ratkeviciute, Draper, UT (US)

(21) Appl. No.: 13/368,039

(22) Filed: Feb. 7, 2012

Related U.S. Application Data
(60) Provisional application No. 61/462,605, filed on Feb. 7, 2011.
(60) Provisional application No. 61/462,606, filed on Feb. 7, 2011.
(60) Provisional application No. 61/462,607, filed on Feb. 7, 2011.

(51) Int. Cl. G06F 19/00; G06F 15/18; G06N 3/08; H01B 5/00

(52) U.S. Cl. 702/109; 174/126.1; 706/12; 706/21

(57) ABSTRACT

An electrical wire includes a core comprising an electrically conductive material that conducts electricity along the length of the electrical wire. The core also includes an acoustic conductive material that conducts acoustic waves along the length of the electrical wire. The core also includes an acoustic waveguide that provides internal reflection for the acoustic waves conducted through the core, and that guides the acoustic waves along the length of the electrical wire. The response acoustic wave signals may be compared against a failure model for the wire in order to determine the reliability of the electrical wire.

### CROSS-REFERENCE TO RELATED APPLICATION

This application claims the benefit of the following applications: U.S. Provisional Patent Application 61/462,605, filed on Feb. 7, 2011, and entitled “Metallic Conductor with Integrated Acoustic Waveguide” for William Kurt Dobson and Zivile Ratkeviciute, which is incorporated herein by reference; U.S. Provisional Patent Application 61/462,606, filed on Feb. 7, 2011, and entitled “Metallic Conductor with Integrated Optical Waveguide” for William Kurt Dobson and Zivile Ratkeviciute which is incorporated herein by reference; and U.S. Provisional Patent Application 61/462,607, filed on Feb. 7, 2011, and entitled “Method for Acousto Optical Detection of Wire Degradation in Vivo” for William Kurt Dobson and Zivile Ratkeviciute which is incorporated herein by reference.

### FIELD

The invention relates to electrical wires and approaches for testing the integrity of the same.

### BACKGROUND

Wires are foundational components in today's electronic world. Wires are used to carry electricity for various purposes—the wires may be used to transport power from one location to another, to provide communications via electrical signals, and other functions. Wires usually have an electrical conductor through which the electric current flows. Copper is a common conductor in electrical wires, but other materials (such as silver, gold, and aluminum) and combinations of materials may be used for the electrical conductor depending on the needs of the particular system. Electrical wires typically include insulating materials as well, such as plastic or polymers.

Because wires may transmit electricity to critical systems, the integrity of the wires is important. For example, a failure in a wire in an airplane, a car, or a medical device can be catastrophic. However, like all things, wires fatigue and age and may need periodic replacement. Preventing problems due to wire failure can be complicated.

In certain systems, redundant wiring is used for complex or critical applications. However, redundant wiring can be expensive, and is no guarantee against failure. Furthermore, redundant wiring does little to help predict when a wire will fail, or if there are problems with the wire.

Approaches have been developed to test wire integrity. For example, time-domain reflectometry (TDR) is a technique used to determine characteristics of a wire by observing reflected waveforms when a signal is introduced onto the wire. When the signal encounters a discontinuity, a portion of the signal is reflected. The location of the discontinuity can often be determined based on the reflected portion of the signal. There are various types of TDR, such as spread-spectrum time-domain reflectometry (SSTDR), and variations in the frequency and wavelet domains.

TDR provides approaches to testing the integrity of wires, and some (such as SSTDR) can be used to test in high-noise and live environments. However, these methods typically use radio frequency (RF) electromagnetic signals that travel at some large fraction of the speed of light through the conductor in the wire. As a result, it can be difficult to precisely determine the location of a fault using traditional electromagnetic approaches, particularly in shorter lengths of wire.

In addition, traditional TDR approaches are believed to be used only to find existing faults; they have not been used to find developing faults, or deterioration that has not yet resulted in a failure. This can be a problem in various environments. For example, with an implantable biomedical device, death may follow within minutes of a wire failure. Finding the fault only after failure has occurred in such an environment is not acceptable.

### SUMMARY

In one aspect, the subject matter of the present application is an electrical wire that includes a core extending along a length of the electrical wire. The core comprises an electrically conductive material configured to conduct electricity along the length of the electrical wire. The core also comprises an acoustic conductive material configured to conduct one or more acoustic waves along the length of the electrical wire. The electrical wire also comprises an acoustic waveguide that provides internal reflection for acoustic waves conducted through the core, and that guides acoustic waves conducted through the core along the length of the electrical wire. The acoustic waveguide may sheath the acoustic conductive material in the core. The core may be solid core, or stranded core. In one implementation, the core may be made using copper, and the acoustic waveguide using brass.

The core may be made from a first material that has a first propagation speed for acoustic waves, while the acoustic waveguide may be made from a second material with a second propagation speed for acoustic waves that is greater than the first propagation speed. The acoustic waveguide may be energetically coupled to the core such that defects in the core affect acoustic waves conducted on the core. The electrical wire may also include an insulation layer that sheaths the acoustic waveguide. The acoustic waveguide may also be energetically coupled to the insulation layer such that defects in the insulation layer affect acoustic waves conducted on the core.

The invention may also include a system for predicting a failure of an electrical wire that includes an acoustic waveguide in a live electrical environment. The system may include an acoustic signal generator that couples to the electrical wire and introduces a longitudinal acoustic wave signal into the electrical wire and that propagates the acoustic wave signal down the length of the electrical wire. The system may also include an acoustic receiver that receives a response acoustic wave signal from the electrical wire. The response acoustic wave signal is the acoustic wave signal affected by the electrical wire. The system may also include a failure prediction module that compares the response acoustic wave signal with a failure model for the electrical wire in the live electrical environment, and that determines reliability of the electrical wire based on the comparison of the response acoustic wave signal and the failure model. The failure prediction module may also identify defects in the electrical wire.

The acoustic wave signal generator may include a transducer in transmit mode, and the acoustic receiver may include a transducer in receive mode. The transducer may be coupled to the first end of the electrical wire and initially be in transmit mode. The acoustic signal generator may be configured to switch the transducer to receive mode after introducing the acoustic wave signal into the electrical wire.

The system may also include a learning module that receives failure data for test wires that are tested to failure, and that generates the failure model based on the failure data. The learning module may include an artificial neural network. The system may also include a fatigue module that tests the test wires to failure in order to generate the failure data.

The invention may be realized as a method for testing an electrical wire comprising an acoustic waveguide. The method may involve introducing an acoustic wave signal into an electrical wire in a live electrical environment by longitudinal excitement of the electrical wire, and receiving a response acoustic wave signal from the electrical wire. The method may also involve comparing the response acoustic wave signal with a failure model for the electrical wire in the live electrical environment and determining reliability of the electrical wire based on the comparison of the response acoustic wave signal and the failure model.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is an illustration of one embodiment of an electrical wire that includes an acoustic waveguide;

FIG. 2 is a schematic block diagram showing one embodiment of a system for monitoring an electrical wire including an acoustic waveguide;

FIG. 3 is a schematic block diagram showing another embodiment of a system for monitoring an electrical wire;

FIG. 4 is a schematic block diagram showing an embodiment of a system for developing a failure model for an electrical wire;

FIG. 5 is a flow chart diagram showing an embodiment of a method for monitoring an electrical wire;

FIG. 6 is a flow chart diagram showing an embodiment of a method for developing a failure model for an electrical wire;

FIG. 7 is an illustration of one embodiment of an electrical wire that includes an optical waveguide;

FIG. 8 is a schematic block diagram showing one embodiment of a system for monitoring an electrical wire including an optical waveguide; and

FIG. 9 is a schematic block diagram showing an embodiment of a method for developing a failure model for an electrical wire including an optical waveguide.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in microcode, firmware, or the like of programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. Modules may be stored on non-transitory computer readable storage media.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. The computer readable medium may be non-transitory.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-Ray Disc (BD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fibre cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fibre optic cable for execution by a processor and stored on RAM storage device for execution by the processor.

Computer readable program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. These computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer-readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer-readable program code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

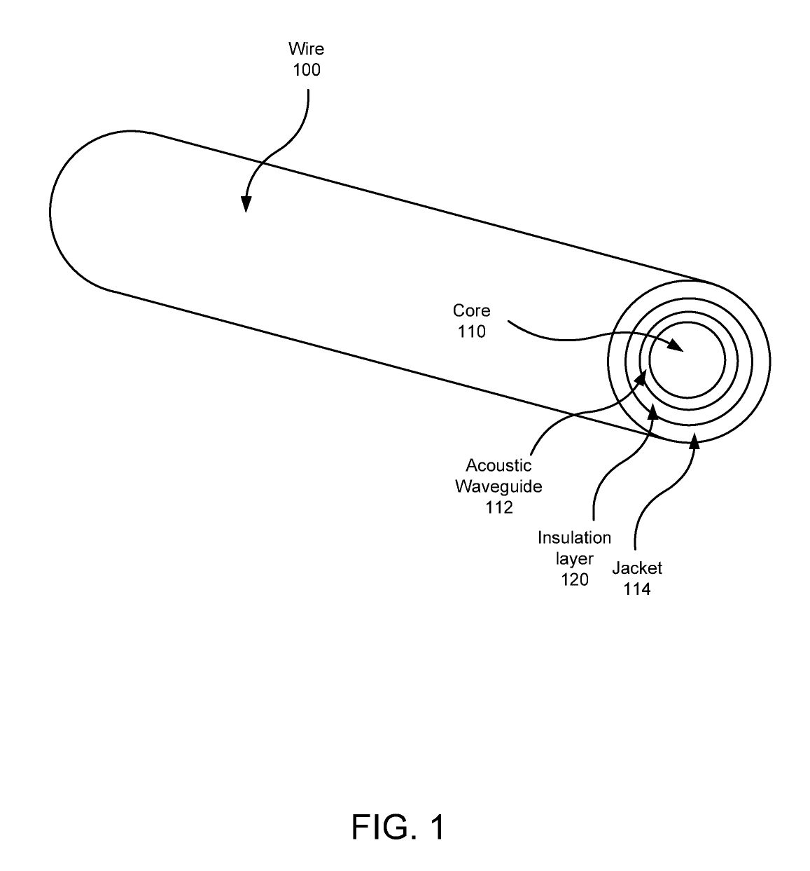

FIG. 1 shows one embodiment of an electrical wire 100. The electrical wire 100 is used to transport electricity along the length of the electrical wire 100. The electrical wire 100 may be any of the many varieties, and for any purpose. For example, the electrical wire 100 may be used to transport electricity to power a connected device, such as an artificial heart. The electrical wire 100 may be used to transport electrical signals that are used for communications purposes; for example, the electrical wire 100 may be category 5 cable, coaxial cable, or other varieties of electrical wire 100. The uses and variety of electrical wire 100 will be appreciated by those of skill in the art.

The electrical wire 100 shown in FIG. 1 includes a core 110, an acoustic waveguide 112, and a jacket 114. The electrical wire 100 may include other components beyond, or different from, those shown in FIG. 1. The core 110 extends along the length of the electrical wire 100 and comprises an electrically conductive material configured to conduct electricity along the length of the electrical wire 100. The core 110 may be made using any suitable electrically conductive material, and the material may vary based on application. Materials suitable for use in the core 110 of an electrical wire 100 include, for example, copper, silver, platinum, aluminum, gold, and various alloys.

The core 110 may be solid core, consisting of a single strand of wire, or may be a stranded core that is composed of a bundle of wires to make a larger conductor. The core 110 may also be made using combinations of different materials; for example, the electrical wire 100 may be designed for use at high frequencies, such that current will travel near the surface of the core 110 because of the skin effect. The core 110 for such an application may include a nickel core with an outer skin made of copper in such an embodiment.

The core 110 also includes an acoustic conductive material that conducts one or more acoustic waves along the length of the electrical wire 100. An acoustic conductive material is a material capable of serving as a medium for acoustic waves introduced into the electrical wire 100. The core 110 may be made using a material that conducts both electricity and acoustic waves. For example, a copper core 110 can conduct both electricity and acoustic waves. In other embodiments, the core 110 may include a first component that conducts electricity, and a separate second component that conducts acoustic waves.

Defects in the core 110 may affect the ability of the electrical wire 100 to conduct electricity. As the electrical wire 100 ages, the defects in the core 110 may mount until the electrical wire 100 fails. Ideally, the integrity of the electrical wire 100 can be evaluated before the electrical wire 100 fails.

The electrical wire 100 also includes an acoustic waveguide 112. The acoustic waveguide 112 provides internal reflection for acoustic waves conducted through the core 110, and guides the acoustic waves conducted through the core 110 along the length of the electrical wire 100. The acoustic waveguide 112 thus helps propagate the acoustic waves introduced onto the core 110 down the length of the electrical wire 100. In certain embodiments, the acoustic waveguide 112 sheaths the acoustic conductive material in the core 110 down the length of the electrical wire 110. The acoustic waveguide 112 may be made of a material that reflects acoustic waves introduced onto the core 110 such that the acoustic wave is guided along the length of the electrical wire 110. The acoustic waveguide 112 does not significantly attenuate the acoustic wave.

The acoustic waveguide 112 may be a cladding made of a material that is an electrical conductor, or a material that is an electrical insulator. In certain embodiments, the acoustic waveguide 112 is made of a combination of materials that reflect the acoustic waves introduced into the core 110 sheathed by the acoustic waveguide 112. While FIG. 1, and other figures, shows the acoustic waveguide 112 as an actual layer in the electrical wire 100 separate from other layers in the electrical wire 100, this need not be the case in all embodiments. For example, in certain embodiments, the acoustic waveguide 112 may be composed of a layer of the core 110 in conjunction with the insulation layer 120. Other cladding materials in the electrical wire 100 may also serve to act as an acoustic waveguide 112, whether alone or in isolation. The acoustic waveguide 112 may be formed by both the core 110 and other layers of materials within the electrical wire 100 that provide different propagation speeds for acoustic waves (such as the insulation layer 120). The thickness of the layers of materials may vary to provide appropriate acoustic wave propagation. In such embodiments, the combinations of materials may be considered the acoustic waveguide 112.

The speed at which acoustic waves propagate through a medium depends on the compressibility and density of the medium. The core 110 may be made using a first material having a first propagation speed for acoustic waves. The acoustic waveguide 112 may be made of a second material having a second propagation speed for acoustic waves that is greater than the first propagation speed.

In certain embodiments, the acoustic waveguide 112 and the core 110 are physically separate layers within the electrical wire 100, and the boundary between them is abrupt. For example, in one embodiment, the core 110 may be made of copper, and the acoustic waveguide 112 may be made of brass and sheath the copper core 110. In other embodiments, the boundary between the core 110 and the acoustic waveguide 112 is gradual.

The acoustic waveguide 112 may be energetically coupled to the core 110 such that defects in the core 110 affect the acoustic waves that are conducted on the core 110. The acoustic waveguide 112 may also be energetically coupled to the insulation layer 120 of the electrical wire 100 such that defects in the insulation layer 120 affect the acoustic waves that are conducted on the core 110. When the acoustic waveguide 112 is energetically coupled to the insulation layer 120, some amount of energy from the acoustic wave is permitted to leak through the waveguide 112 to the insulation layer 120, such that defects in the insulation layer 120 affect the acoustic wave in the electrical wire 100. The waveguide 112 may couple a known percentage of the energy to an outer layer (such as the insulation layer 120) in order to find defects in the outer layers.

In certain embodiments, the acoustic waveguide 112 is made of an insulating material such that the acoustic waveguide 112 can act as both an acoustic waveguide 112 and the insulation layer 120. In other embodiments, the acoustic waveguide 112 and the insulation layer 120 are separate layers, with the insulation layer 120 sheathing the acoustic waveguide 112 as shown in the embodiment in FIG. 1.

The electrical wire 100 may also include a jacket 114. The jacket 114 may provide protection for the electrical wire 100, and help protect the electrical wire 100 from cuts, ultraviolet light, and other environmental hazards. The electrical wire 100 may also include other components beyond those shown in FIG. 1. For example, the electrical wire 100 may include a metallic shield to help prevent interference from outside sources, and to help prevent the electrical wire 100 from causing interference with outside sources. The metallic shield may be a braided copper wire situated underneath the jacket 114. The acoustic waveguide 112 may, in certain embodiments, also serve as a metallic shield for the electrical wire 100.

In one example, the core 110 may be made from copper. The density of the copper may be about 8.9366 g/cm³, the Young's modulus may be approximately E=1.155e11. The acoustic speed for pure copper is approximately 3597.12 m/s. For an electrical wire 100 with a diameter of 1 mm, the supported longitudinal frequency mode is 3.597 mHz, which provides a wavelength approximately equal to the diameter of the electrical wire 100. The acoustic waveguide 112 may be made from brass such that the acoustic energy inserted onto the core 110 is contained within the core 110. In certain embodiments, the acoustic waveguide 112 allows some leakage of the acoustic energy to the insulation layer 120.

As a result of this construction, an electrical wire 100 can be tested in a live environment using acoustic waves. Due to the lower speed of acoustic waves, in comparison with electrical impulses, defects in the electrical wire 100 can be detected using less expensive microprocessors that do not have to sample as quickly as those used when integrity testing is done using electrical signals. In addition, using acoustic waves provides increased resolution. For example, a 30 mHz acoustic wave may travel through a typical metallic core 110 at a speed of approximately 3,000 m/s, which yields a wavelength of 0.1 mm. This small wavelength allows detection of defects on approximately the same scale. Furthermore, use of acoustic signals for diagnostics may provide increased accuracy since designers can make more accurate estimates of the velocity of propagation of acoustic waves through the core 110. In contrast, when electrical signals are used to test the integrity of an electrical wire 100, interference from other RF sources may affect the speed of the electrical test signals, and thus decrease accuracy. Many of the events that would impact the propagation speed of acoustic waves in the core 110 (such as a change in density) are possible defects that are desirably detected by the acoustic signal.

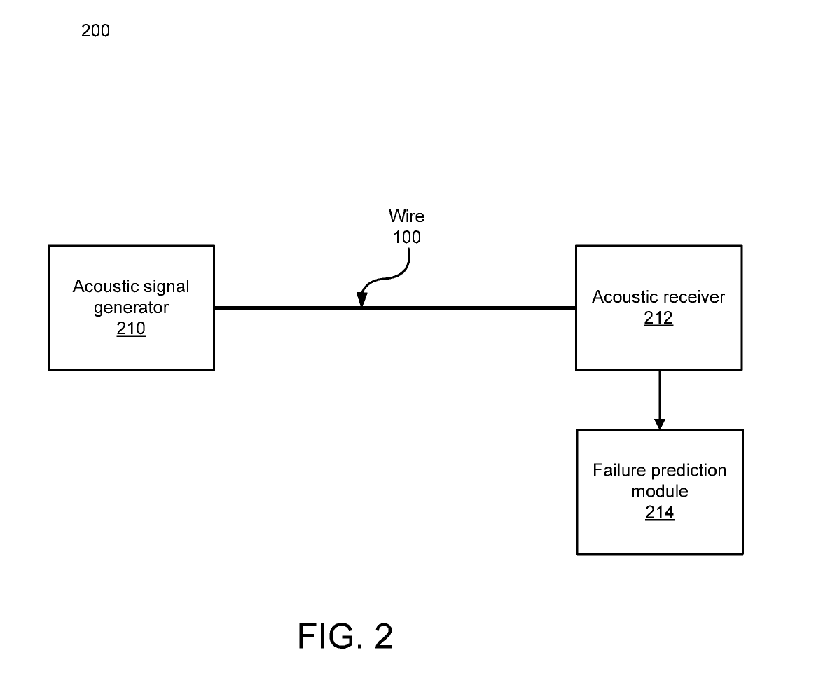

FIG. 2 shows one embodiment of a system 200 for predicting a failure of an electrical wire 100 that includes an acoustic waveguide 112. The system 200 may include an acoustic signal generator 210, an acoustic receiver 212, and a failure prediction module 214. The system 200 may include additional components beyond those shown.

The acoustic signal generator 210 couples to the electrical wire 100 and introduces an acoustic wave signal into the electrical wire 100 and propagates the acoustic wave signal down the length of the electrical wire 100. In one embodiment, the acoustic signal generator 210 introduces a longitudinal acoustic wave signal into the electrical wire 100. A longitudinal acoustic wave signal is an acoustic wave signal caused by compression along the length of the electrical wire 100. In other embodiments, the acoustic signal generator 210 introduces a transverse acoustic wave signal or a rotational acoustic wave signal. Various approaches to generating an acoustic wave signal and introducing that acoustic wave signal onto the electrical wire 100 may be used.

The acoustic signal generator 210 may include a transducer in transmit mode. Such a transducer sends an acoustic wave signal down the electrical wire 100. The acoustic wave signal may be a pulse, or it may be a continuous signal. In certain embodiments, the acoustic signal generator 210 includes a controller that causes the transducer to send the acoustic wave signal and that provides the transducer with information about the shape of the acoustic wave signal to be generated.

The acoustic signal generator 210 may be configured to generate an acoustic wave signal at ultrasonic frequencies. In one embodiment, the acoustic signal generator 210 generates an acoustic wave signal at a frequency that provides a wavelength approximately equal to the diameter of the core 110. The actual frequency may be varied to account for materials used in constructing the electronic wire 100 and for design objectives for energy containment within the acoustic waveguide 112. The frequency of the acoustic wave signal may be varied to allow some leakage in order to couple the acoustic waveguide 112 in outer layers such as the insulation layer 120.

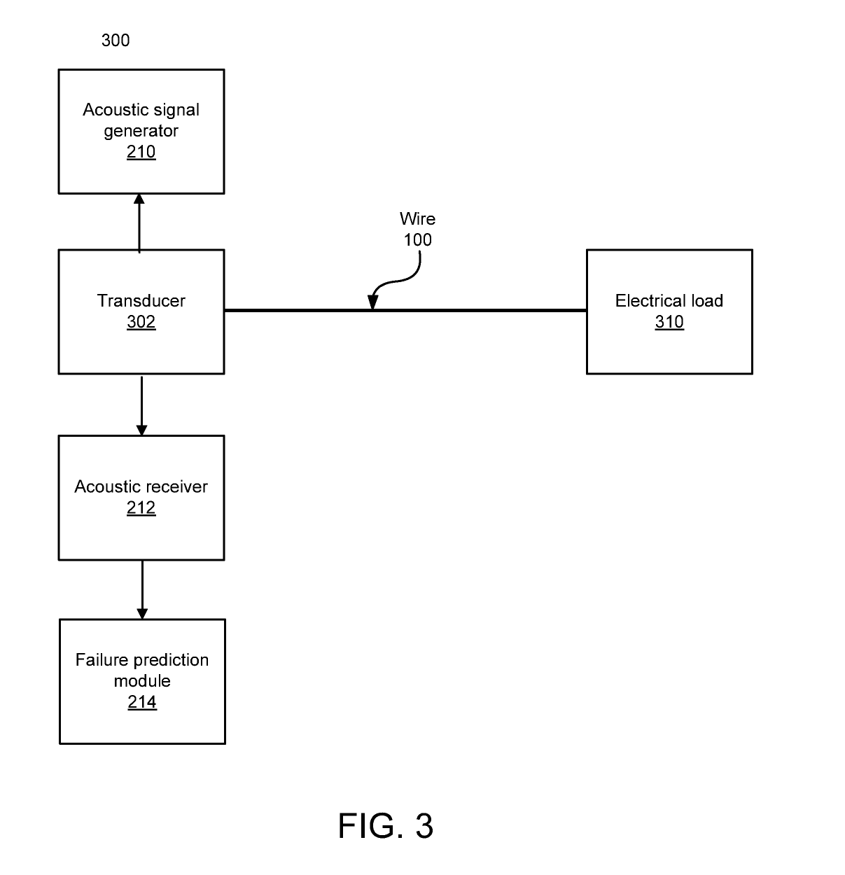

The system 200 may also include an acoustic receiver 212. The acoustic receiver 212 receives a response acoustic wave signal from the electrical wire 100. The response acoustic wave signal is the acoustic wave signal introduced by the acoustic signal generator 210 as affected by the electrical wire 100. For example, in the embodiment shown in FIG. 2, the response acoustic wave signal is the acoustic wave signal introduced by the acoustic signal generator 210, received at the acoustic receiver 212 coupled to the opposite end of the wire 100. In other embodiments, such as the one shown in FIG. 3, the response acoustic wave signal is the echo of the acoustic wave signal introduced by the acoustic signal generator 210. Defects and wear on the electrical wire 100 affects the acoustic wave signal such that the resulting response acoustic wave signal provides information about the state of the electrical wire 100. For example, a crack in the core 110 will affect the acoustic wave signal such that the response acoustic wave signal contains information about the crack in the core 110.

The acoustic receiver 212 may include a transducer in receive mode. The acoustic receiver 212 may receive the response acoustic wave signal from the electrical wire 100 and translate it into a representation of the physical acoustic wave signal. The acoustic receiver 212 may provide the representation of the physical acoustic wave signal to the failure prediction module 214.

The failure prediction module 214 compares the response acoustic wave signal with a failure model for the electrical wire 100 in the live electrical environment. The failure prediction module 214 also determines the reliability of the electrical wire 100 based on the comparison of the response acoustic wave signal and the failure model.

The failure prediction module 214 may compare the response acoustic wave signal with the failure model by comparing a representation of the response acoustic wave signal with one or more representations of acoustic signals in the failure model. The failure prediction module 214 may compare the response acoustic wave signal with the failure module by comparing one or more metrics derived from the response acoustic wave signal (for example, strength of the acoustic signal, transmit time, shape of the acoustic signal) with one or more metrics of the failure model. Based on the comparison, the failure prediction module 214 may determine the reliability of the electrical wire 100.

Determining reliability may involve determining an estimated lifespan for the electrical wire 100. For example, based on comparison of the response acoustic wave signal with the failure model, the failure prediction module 214 may determine that the electrical wire 100 is likely to continue functioning for a specified period of time. The failure prediction module 214 may report the expected usable lifespan for the electrical wire 100 based on the comparison.

Determining reliability may involve determining the likelihood of the electrical wire 100 failing within a certain time span. For example, the failure prediction module 214 may determine the likelihood that the electrical wire 100 will fail in the next week, in the next month, or any time period that a user may want information for. The failure prediction module 214 may use statistical approaches to calculating the likelihood of the electrical wire 100 failing within certain time periods based on comparisons between the response acoustic signal and the failure model. Other measurements and values that reflect the reliability of the electrical wire 100 may be presented instead of, or in addition to, the examples given above.

In certain embodiments, the failure prediction module 214 may also identify defects in the electrical wire 100. The failure prediction module 214 may, for example, identify the type of defect (for example, a crack developing in the core 110) and the location of the defect. Due to the wavelength and speed of acoustic waves in the electrical wire 100, the location of the defects can be detected with increased precision at lower cost. The defects may also be detectable before the electrical wire 100 fails.

FIG. 3 shows another embodiment of a system 300 for predicting a failure of an electrical wire 100 in a live electrical environment. A live electrical environment, as used herein, refers to an environment in which the electrical wire 100 is delivering electrical signals (whether providing power, communications, or other) to an electronic device during normal operations, which electrical signals are used by the electrical device. In one embodiment, the electrical load 310 is an implanted medical device that is implanted and functioning in a patient, and is receiving power or information from the electrical wire 100. Other live electrical environments are also possible.

In FIG. 3 the transducer 302 is shown coupled to a first end of the electrical wire 100, and an electrical load 310 is coupled to a second end of the electrical wire 100. In certain embodiments, the transducer 302 may send an acoustic wave signal for the acoustic signal generator 210, and also receive the response acoustic wave signal for the acoustic receiver 212. In one embodiment, the acoustic signal generator 210 causes the transducer 302 to introduce an acoustic wave signal that is a pulse onto the electrical wire 100. After the acoustic wave signal is introduced, the acoustic receiver 212 may cause the transducer to change from a transmit mode to a receive mode in order to receive the response acoustic wave signal. The response acoustic wave signal may be the echo of the acoustic wave signal that returns to the transducer 302. In certain embodiments, microcontrollers are used to allow the transducer 302 to quickly change from the transmit mode to the receive mode, allowing the same transducer 302 to send the acoustic wave signal and to receive the response acoustic wave signal.

The electrical load 310 is the device in the live electrical environment that receives the electrical signals from the electrical wire 100. The electrical load 310 may be a device being powered by the electrical wire 100, a device receiving communications in the form of electrical signals over the electrical wire 100, or other variety of device. By testing the integrity of the electrical wire 100 using acoustic waves, the possibility of the test signal interfering with the electrical load 310 may be greatly reduced.

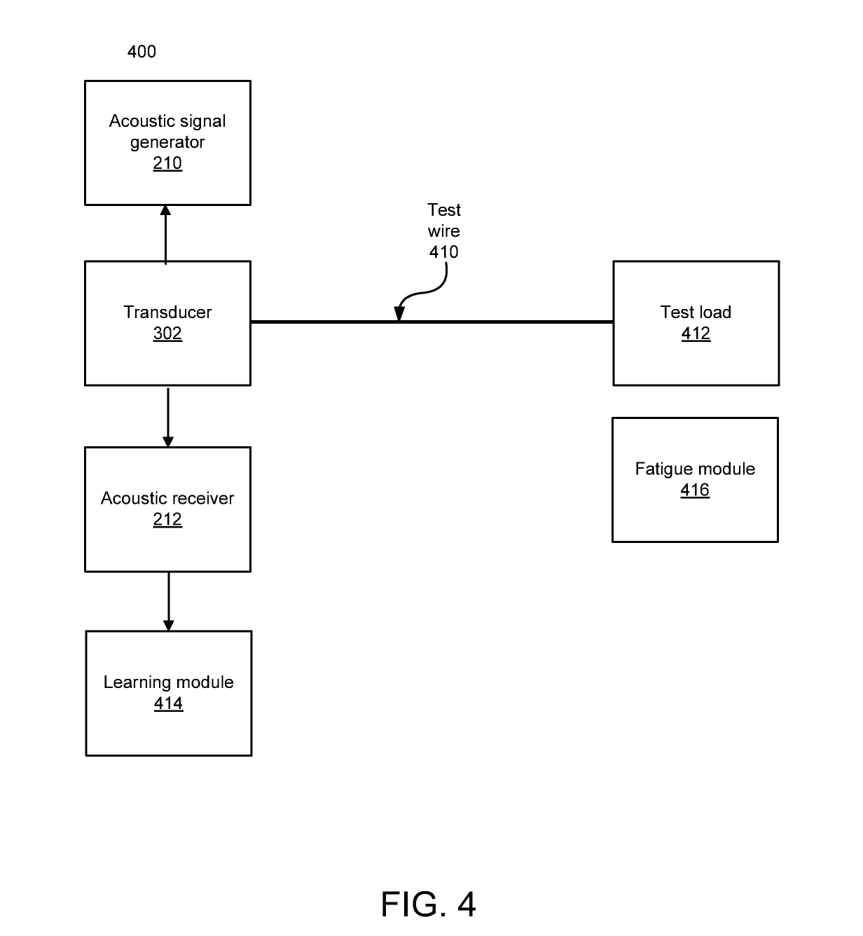

FIG. 4 shows one embodiment of a system 400 for generating a failure model for the electrical wire 100. In one embodiment, the system 400 includes an acoustic signal generator 210, a transducer 302, an acoustic receiver 212, a learning module 414, a test wire 410, a test load 412, and a fatigue module 416.

The test wire 410 is an electrical wire 100 that is comparable to the electrical wire 100 in the live environment that is to be diagnosed. The test wire 410 may include an acoustic waveguide 112. In one embodiment, the test wire 410 is the same type of electrical wire 100 that is used in the live environment; for example, if the electrical wire 100 in the live environment is coaxial cable, the test wire 410 may be coaxial cable.

A person creating the failure model may choose a test wire 410 with more or fewer similarities to the electrical wire 100 to be diagnosed. A test wire 410 that is almost identical to the electrical wire 100 may provide a more accurate failure model; a test wire 410 with fewer similarities may provide a more generally applicable model. For example, the person may select test wires 410 that are the same type of electrical wire 100, and that also have the same construction as the electrical wire 100 in the live environment. To continue the example above, not all coaxial cables are made using the same materials; the person may select test wires 410 that have the same materials for the conductive core 110, the insulation layer 120, and other characteristics of the electrical wire 100 in the live environment. The person may also ensure that the test wires 410 have similar variable characteristics, such as length, as the electrical wire 100 in the live environment.

The system 400 may also include a test load 412. The test load 412 is an electric load that simulates an appropriate electric load for the electrical wire 100. The test load 412 may be identical to the electrical load 310 in the live environment. For example, where the electrical load 310 is an artificial heart, the test load 412 may be the same type of artificial heart powered by the electrical wire 100. In other embodiments, the test load 412 is a device that is suitably comparable to the electrical load 310. For example, the test load 412 may not be an artificial heart, but a device that is draws a comparable amount of power in comparable way to the artificial heart that is the electrical load 310. As above, the degree to which the test load 412 matches the electrical load 310 may be a design parameter that varies with the needs of the designer.

The system 400 may also include a fatigue module 416. The fatigue module 416 may be configured to test the test wire 410 to failure. The fatigue module 416 may cause the acoustic signal generator 210 and the acoustic receiver 212 to use the transducer 302 to send acoustic wave signals and receive response acoustic wave signals over the test wire 410 coupled to the test load 412. The fatigue module 416 may cause this process to repeat until the test wire 410 fails. The fatigue module 416 may monitor for a failure of the test wire 410. What constitutes failure of the test wire 410 may vary from application to application. In certain embodiments, intermittent faults may be deemed failures. In other environments, a failure may be a total failure of the test wire 410.

The fatigue module 416 may be further configured to simulate conditions of the live environment. For example, the fatigue module 416 may cause the test wire 410 to twist and bend during testing, introduce moisture into the environment, or perform other actions to simulate the conditions of the live environment. The fatigue module 416 may be configured to introduce conditions that cause the test wire 410 to wear out faster than the electrical wire 100 in the live environment.

In certain embodiments, more than one test wire 410 is tested at a given time. The system 400 may be configured to test a plurality of test wires 410 at a time in order to speed the development of the failure model. In other embodiments, the test wires 410 are tested sequentially.

The system 400 may also include a learning module 414 that receives failure data for the test wires 410 tested to failure, and that generates the failure model based on the failure data. Failure data refers to data gathered during the testing of the test wire 410 that shows the test wire 410 degrading during testing. In one embodiment, the learning module 414 receives the failure data from the acoustic receiver 212. The learning module 414 may receive the failure data for a plurality of test wires 410 tested to failure.

In one embodiment, the learning module 414 comprises an artificial neural network (ANN), also commonly referred to as neural networks. An ANN consists of a group of nodes that find patterns and create models using connectionist approaches to computation. The ANN may allow the learning module 414 to receive failure data for the test wires 410 and to build a failure model that represents the failure of an electrical wire 100. The response acoustic wave signal from the electrical wire 100 in the live environment can be compared with the failure model to make intelligent predictions about the state of, and lifespan of, the electrical wire 100 in the live environment.

For a learning module 414 comprising an ANN, a variety of approaches can be used to create the failure model. The ANN may use supervised learning, unsupervised learning, reinforcement learning, or various learning approaches to create the failure model from the failure data for the one or more test wires 410. In preferred embodiments, the learning module 414 is trained using the failure data from a plurality of test wires 410 tested to failure. In certain embodiments, a designer tests the robustness of the resulting failure model prior to deploying the failure model to make predictions about electrical wires 100 in a live environment.

In certain embodiments, the response acoustic wave signals on the electrical wire 100 in the live environment are also provided to the learning module 414. The learning module 414 may further refine the failure model based on the response acoustic wave signals in the live environment.

In one embodiment, the acoustic receiver 212 can communicate the response acoustic wave signals to the learning module 414 over a network connection such as the Internet. Similarly, the failure model may be stored on a remote server that can be accessed by the failure prediction module 214. Having a centrally hosted failure model that is continuously refined with new data may allow the failure model to become increasingly accurate.

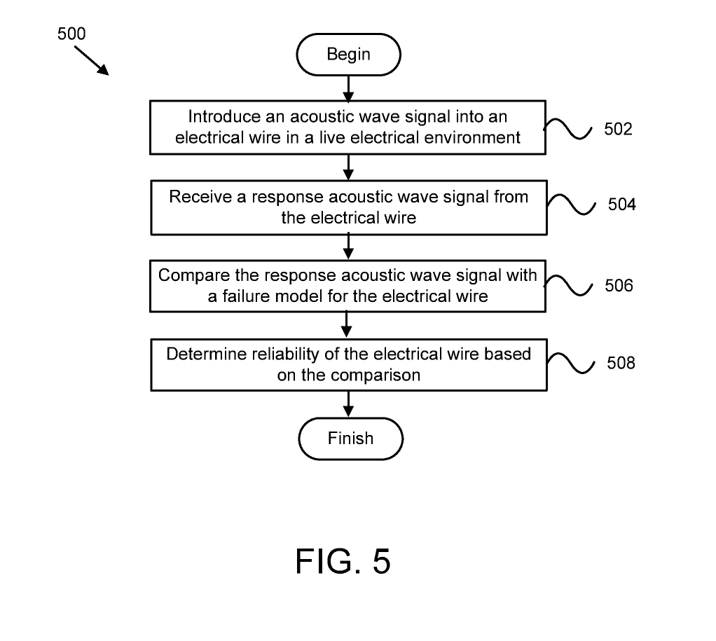

FIG. 5 shows one embodiment of a method 500 for testing an electrical wire 100 in a live environment. The method 500 begins with introducing 502 an acoustic wave signal into an electrical wire 100 in a live electrical environment. The acoustic wave signal may be introduced by longitudinal excitement of the electrical wire 100 that includes an acoustic waveguide 112.

The method 500 may also involve receiving 504 a response acoustic wave signal from the electrical wire 100. The response acoustic wave signal, as explained above, is the acoustic wave signal introduced onto the electrical wire 100 as affected by the electrical wire 100. The method 500 may involve comparing 506 the response acoustic wave signal with a failure model for the electrical wire 100, and determining 508 the reliability of the electrical wire 100 based on the comparison of the response acoustic wave signal and the failure model.

The method 500 may also involve selecting one or more threshold reliability metrics for the electrical wire 100. Reliability metrics refer to values that represent the reliability of the electrical wire 100. One threshold reliability metric may, for example, represent the likelihood that the electrical wire 100 will fail within a month. Another threshold reliability metric may be the amount of distortion to the acoustic wave signal. Another threshold reliability metric may be the number of cracks in the core 110, the insulation layer 120, or other component of the electrical wire 100. Other threshold reliability metrics may also be used.

In certain embodiments, determining the reliability of the electrical wire 100 based on the comparison between the response acoustic wave signal and the failure model may involve designating the electrical wire 100 as unreliable if the comparison between the response acoustic wave signal and the failure model indicates that the electrical wire 100 exceeds one or more of the threshold reliability metrics.

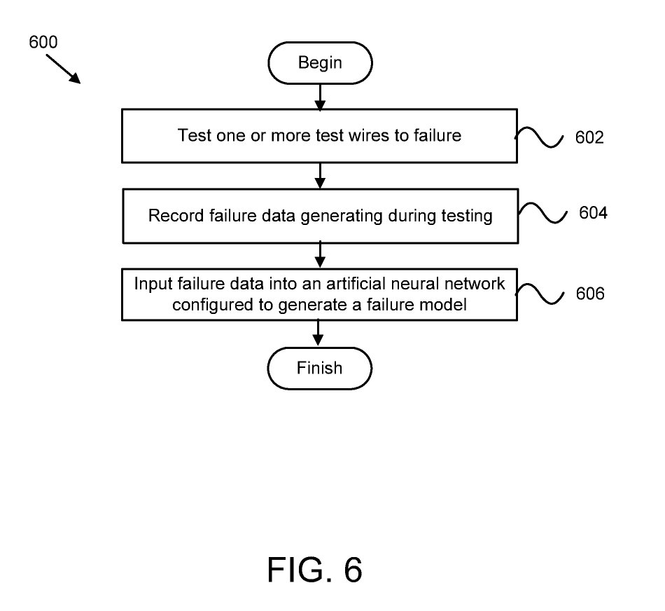

FIG. 6 shows one embodiment of a method 600 for generating a failure model for an electrical wire 100. In one embodiment, the method 600 begins with testing 602 one or more test wires 410 to failure. The testing may be done in a live electrical environment. The testing may, in certain embodiments, be done in an environment that simulates the live electrical environment.

The method 600 may also involve recording 604 the failure data that is generated during testing of the test wires 410. The failure data may comprise response acoustic signals generated over the life of the test wire 410 during testing. The failure data may comprise data showing the differences between the acoustic wave signal and the response acoustic wave signal over the life of the test wire 410. Other types of failure data may also be used.

The method 600 may also involve inputting 606 the failure data into an artificial neural network that is configured to generate a failure model for the electrical wire 100 based on the failure data generated from testing the test wires 410. The ANN may be any of the variety of ANN configurations available. The ANN may continue to receive failure data for electrical wires 100 in live environments in order to continue refining the failure model.

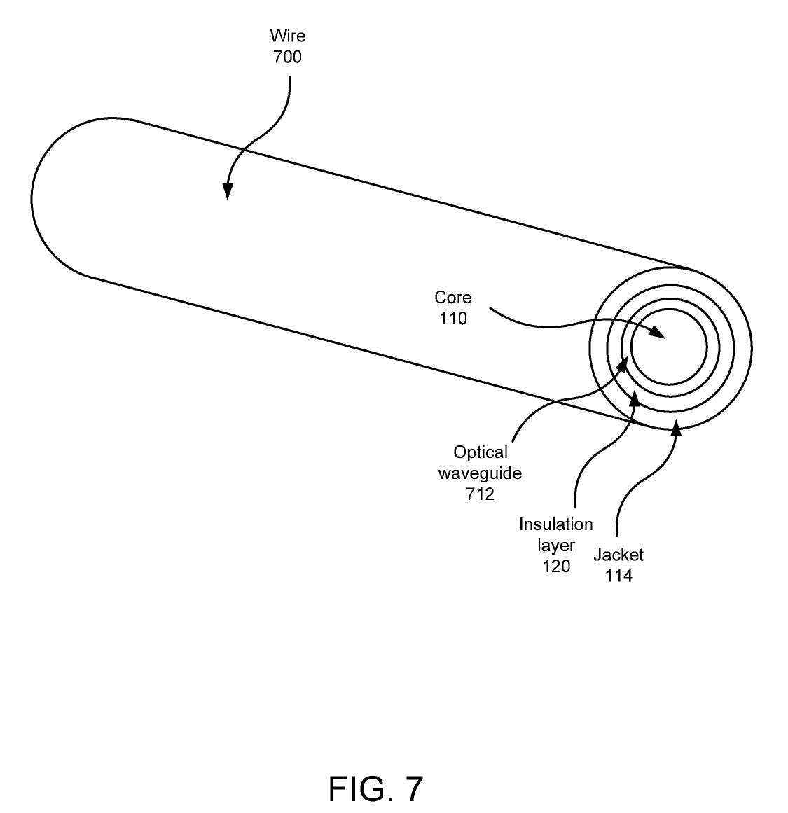

FIG. 7 shows an embodiment of an electrical wire 700 with an integrated optical waveguide 712. The electrical wire 700 may include a core 110 for conducting electricity, as described above. The electrical wire 700 may also include an insulation layer 120 and a jacket 114, as described above. The electrical wire 700 may include additional layers and elements beyond those shown in the depicted embodiment, depending on the uses for the electrical wire 700. The electrical wire 700 also includes one or more optical conductors that conduct one or more optical signals down the length of the electrical wire 700. In certain embodiments, the optical conductor and the optical waveguide 712 are the same physical structure.

The optical waveguide 712 may be configured to receive an optical signal. An optical signal, as used in this application, refers to a signal that comprises one or more photons. In one embodiment, the optical waveguide 712 is an optical fiber. The optical fiber may be wrapped around the core 110 of the electrical wire 700. In certain embodiments, the optical fiber is wrapped around the core 110 in a helical fashion. In another embodiment, the optical fiber travels back and forth along the length of the electrical wire 700 in a serpentine fashion. Other configurations in which an optical fiber can be arranged in the electrical wire 700 may also be used. In certain embodiments, a configuration is selected that provides necessary flexibility for the electrical wire 700.

In certain embodiments, the optical waveguide 712 may be formed using photonic-crystal fiber PCF. The optical waveguide 712 may be formed from a photonic-bandgap fiber that confines and guides light by band gap effects. In one embodiment, the conductor 110 is coated in a liquid polymer that conducts light, and a photonic bandgap pattern is given a pattern that creates bandgaps in the coating. In certain embodiments, the polymer is treated with ultraviolet (UV) light in order to permanently change the refractive index of the polymer. The pattern can be any pattern (helical, serpentine, or other) and can be used to provide adequate coverage of the core 110 such that defects in the core 110 affect the optical signal introduced into the optical waveguide 712. The pattern may be created using lithography methods, or other suitable methods.

The optical waveguide 712 may vary in size based on the needs of a particular implementation. In one embodiment, the optical waveguide 712 is formed from an optical strip having photonic bandgap structures with a size on the order of seven to ten wavelengths. The thickness of the optical strip may be less than 10 um for infrared wavelengths.

In certain embodiments, the electrical wire 700 may have multiple optical waveguides 712. For example, a first optical waveguide 712 may be surrounded by the core 110 such that the first optical waveguide 712 can detect defects in the interior of the core 110. A second optical waveguide 712 may be formed on the exterior of the core 110 and be encompassed by the insulation layer 120. The second optical waveguide 712 may be used to monitor for defects in the exterior of the core 110 and in the insulation layer 120.

In one embodiment, the electrical wire 700 may include both an optical waveguide 712 and an acoustic waveguide 112. The electrical wire 700 may, in such an embodiment, be tested for reliability using both acoustic wave signals and optical signals. The results of the acoustic wave signal testing and the optical signal testing may be correlated to provide a more accurate understanding of the electrical wire 700.

The optical waveguide 712 may be energetically coupled to the core 110 such that degradation in the core 110 affects the optical signal in a manner that can be detected. The optical waveguide 712 may be designed to couple to both the core 110 and the insulation layer 120 such that a single optical waveguide 712 structure can be used to monitor for defects in the insulation layer 120 and the core 110.

Use of optical signals in the visible to infrared spectrum provides defect resolution of approximately 500 nm to 1.5 um. Thus, an electrical wire 700 having an optical waveguide 712 may allow users to detect with great accuracy the presence, and location of, defects before the defects result in a failure of the electrical wire 700.

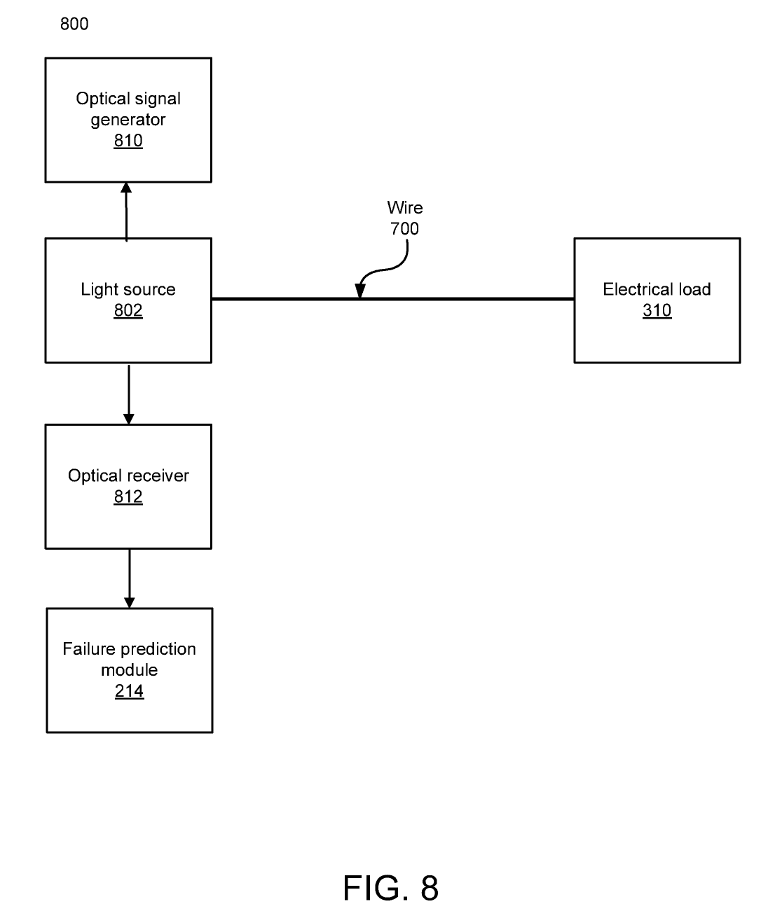

FIG. 8 shows one embodiment of a system 800 for detecting faults in an electrical wire 700 including an optical waveguide 712. In one embodiment, the system 800 includes an optical signal generator 810, a light source 802, an optical receiver 812, and a failure prediction module 214. The example shown in FIG. 8 is simply one example of a possible system; other configurations (such as one comparable to that shown in FIG. 2) are also possible.

The system 800 may include an optical signal generator 810 that introduces an optical signal into the electrical wire 700 and that propagates the optical signal down the length of the electrical wire 700. The optical signal generator 810 may comprise a light source 802 that introduces the optical signal into the optical waveguide 712 of the electrical wire 700. The light source 802 may be a laser diode or other suitable device for inputting an optical signal onto the electrical wire 700. The system 800 may also include an optical receiver 812 that receives a response optical signal from the electrical wire 700. The response optical signal is the optical signal introduced by the optical signal generator 810, as affected by the electrical wire 700.

The system 800 may also include a failure prediction module 214, as described above, that compares the response optical signal with a failure model for the electrical wire 700 in the live electrical environment, and that determines the reliability of the electrical wire 700 based on the comparison of the response optical signal and the failure model.

The failure prediction module 214 may be further configured to identify the location of any defects found on the electrical wire 700. The failure prediction module 214 may also be configured to identify the type of defect found on the electrical wire 700. The failure prediction module 214 may be able to identify the locations of the defects with great precision. The failure prediction module 214 may find defects in the electrical wire 700 based on the response optical signal by solving for coupled energy, mixing at the optical frequency and detection of the subsequent fringes. The failure prediction module 214 may find defects by using optical time-domain reflectometer (OTDR) methods. As with the acoustic case discussed above, the spectrum of the diagnostic signals on the electrical wire 700 are orders of magnitude different from the spectrum used for the electric signals carried on the wire 700 to the electrical load 310. As a result, the diagnostic signals are unlikely to interfere with the electrical load 310 or other aspects of the electrical wire 700 through the introduction of additional electrical signals into the system 800.

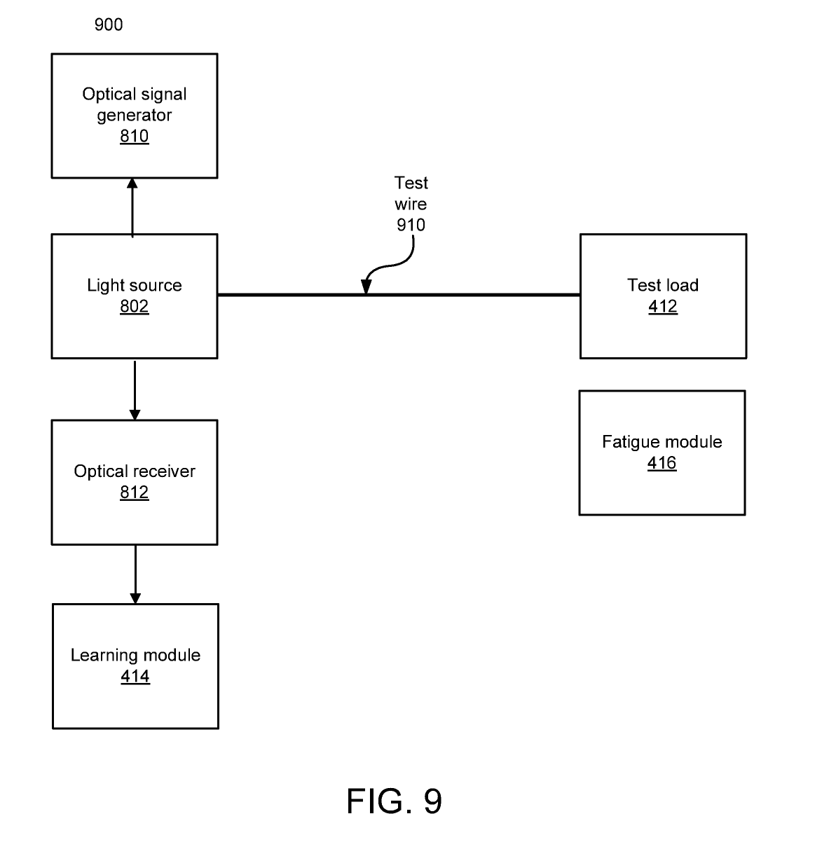

FIG. 9 shows one embodiment of a system 900 for generating a failure model for an electronic wire 700 comprising an optical waveguide 712. The system 900 may include an optical signal generator 810, a light source 802, an optical receiver 812, a learning module 414, a test load 412, and a fatigue module 416.

The optical signal generator 810 and the optical receiver 812 may be configured to send and receive optical signals on test wires 910 comprising optical waveguides 712. The fatigue module 416 may be configured to test one or more test wires 910 to failure. The learning module 414 may receive failure data as the test wire 910 is tested to failure. The learning module 414 may create a failure model for the electronic wire 700 based on the response optical signals received by the optical receiver 812. The discussion above as to the creation of the failure model in connection with the acoustic signal embodiment may be applied to optical signals in order to create a failure model for electrical wires 700 including optical waveguides 712.

In certain embodiments, an electrical wire 700 may include both an acoustic waveguide 112 and an optical waveguide 712. In such an embodiment, a system for testing the electrical wire 700 may include both an optical signal generator 810 and an acoustic signal generator 210 for generating both optical signals and acoustic wave signals on the electrical wire 700. The system may also include both an acoustic receiver 212 and an optical receiver 812. The system may take approaches for training and creating a failure model for the electrical wire 700 as described above.

In one embodiment, the optical signal and the acoustic wave signal are introduced into the electrical wire 700 substantially simultaneously, such that the optical signal and the acoustic wave signal are both on the electrical wire 700 at the same time. In other embodiments, the acoustic wave signal and the optical signal are sent at different times. In certain embodiments, the system may consider optical wave signals sent alone, acoustic wave signals sent alone, and optical wave signals and acoustic wave signals sent onto the electrical wire 700 at the same time in diagnosing the electrical wire 700.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an”, is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

What is claimed is:

1. An electrical wire comprising:
a core extending along a length of the electrical wire, the core comprising an electrically conductive material configured to conduct electricity along the length of the electrical wire;
the core further comprising an acoustic conductive material configured to conduct one or more acoustic waves along the length of the electrical wire; and
an acoustic waveguide that provides internal reflection for acoustic waves conducted through the core and that guides acoustic waves conducted through the core along the length of the electrical wire.

2. The electrical wire of claim 1, wherein the acoustic waveguide sheaths the acoustic conductive material in the core.

3. The electrical wire of claim 1, wherein the core is made using a first material having a first propagation speed for acoustic waves, and wherein the acoustic waveguide is made using a second material having a second propagation speed for acoustic waves that is greater than the first propagation speed.

4. The electrical wire of claim 1, wherein the acoustic waveguide is energetically coupled to the core such that defects in the core affect acoustic waves conducted on the core.

5. The electrical wire of claim 4, further comprising an insulation layer that sheaths the acoustic waveguide.

6. The electrical wire of claim 5, wherein the acoustic waveguide is further energetically coupled to the insulation layer such that defects in the insulation layer affect acoustic waves conducted on the core.

7. The electrical wire of claim 1, wherein the core is one of solid core and stranded core.

8. The electrical wire of claim 1, wherein the core comprises copper and the acoustic waveguide comprises brass.

9. A system for predicting a failure of an electrical wire comprising an acoustic waveguide in a live electrical environment, the system comprising:
an acoustic signal generator that couples to the electrical wire and introduces a longitudinal acoustic wave signal into the electrical wire and that propagates the acoustic wave signal down the length of the electrical wire;
an acoustic receiver that receives a response acoustic wave signal from the electrical wire, wherein the response acoustic wave signal is the acoustic wave signal affected by the electrical wire;
a failure prediction module that:
compares the response acoustic wave signal with a failure model for the electrical wire in the live electrical environment;
determines reliability of the electrical wire based on the comparison of the response acoustic wave signal and the failure model.

10. The system of claim 9, wherein the acoustic wave signal generator comprises a transducer in a transmit mode, and wherein the acoustic receiver comprises a transducer in a receive mode.

11. The system of claim 10, wherein the transducer operating in the transmit mode is coupled to a first end of the electrical wire, the acoustic signal generator further configured to switch the transducer to receive mode after introducing the acoustic wave signal into the electrical wire.

12. The system of claim 9, further comprising a learning module that receives failure data for one or more test wires tested to failure and that generates the failure model based on the failure data.

13. The system of claim 12, wherein the learning module comprises an artificial neural network.

14. The system of claim 12, further comprising a fatigue module that tests the one or more test wires to failure.

15. The system of claim 9, the failure prediction module further configured to identify a defect in the electrical wire.

16. A method comprising:
introducing an acoustic wave signal into an electrical wire in a live electrical environment by longitudinal excitement of the electrical wire, the electrical wire comprising an acoustic waveguide;
receiving a response acoustic wave signal from the electrical wire, wherein the response acoustic wave signal is the acoustic wave signal affected by the electrical wire;
comparing the response acoustic wave signal with a failure model for the electrical wire in the live electrical environment; and
determining reliability of the electrical wire based on the comparison of the response acoustic wave signal and the failure model.

17. The method of claim 16, further comprising testing one or more test wires to failure and recording failure data generated during the testing.

18. The method of claim 17, further comprising inputting the failure data generated during the testing into an artificial neural network configured to generate the failure model.

19. The method of claim 16, further comprising selecting one or more threshold reliability metrics for the electrical wire.

20. The method of claim 19, wherein determining reliability of the electrical wire further comprises determining that the electrical wire is unreliable in response to the comparison between the response acoustic wave signal and the failure model indicating that the electrical wire exceeds the one or more threshold reliability metrics.
